(19) United States
(12) Patent Application Publication
(10) Pub. No.: US 2018/0040030 A1
(43) Pub. Date: Feb. 8, 2018

(54) CENTRAL TRUSTED ELECTRONIC COMMERCE PLATFORM THAT LEVERAGES SOCIAL MEDIA SERVICES

(71) Applicant: International Business Machines Corporation, Armonk, NY (US)

(72) Inventors: Bryan C. Childs, Poughkeepsie, NY (US); Benjamin P. Segal, Hyde Park, NY (US); Peter G. Spera, Pleasant Valley, NY (US)

(21) Appl. No.: 15/229,446

(22) Filed: Aug. 5, 2016

(51) Int. Cl. G06Q 30/02; G06Q 20/10; H04L 12/58; H04L 29/06; H04L 29/08

(52) U.S. Cl. CPC G06Q 30/0269; H04L 63/08; H04L 67/306; H04L 51/32; G06Q 30/0277; G06Q 20/102; H04L 2463/102; G06Q 50/01

(57) ABSTRACT

Systems, methods, and computer-readable media for integrating e-commerce capabilities with social media services using a central trusted service are disclosed. A client application executable on a client device interacts with a central trusted e-commerce/social media service executing on one or more servers. The central trusted service receives social networking credentials associated with a user from the client application and identifies a particular user profile associated with the user based at least in part on the received social networking credentials. The central trusted service determines a trusted group of user profiles linked to the particular user profile and analyzes various types of data associated with the trusted group of user profiles to identify products to recommend to the particular user profile. In addition, the central trusted service provides a direct, centralized conduit to online retailers to allow the user to purchase a product via a trusted and secure mechanism.

### BACKGROUND

Social media services provide the capability for online users to form virtual online communities with one another. For example, users may utilize a social media service to establish online social connections with those that share a common interest. Certain existing electronic commerce (e-commerce) platforms provide targeted advertisements to users based on their social media interactions. However, such existing e-commerce platforms fail to, among other things, directly connect virtual social media interactions with online purchasing capabilities. Technical solutions that address these and other drawbacks of existing social media services and existing electronic commerce platforms are described herein.

### SUMMARY

In one or more example embodiments of the disclosure, a method for enabling electronic commerce using social media services is disclosed. The method includes receiving, by a central trusted server from a client application executing on a client device, social networking credentials associated with a particular user profile. The method further includes determining a group of one or more trusted user profiles associated with the particular user profile, and determining a product or service to recommend to the particular user profile based at least in part on an analysis of online activity associated with the group of one or more trusted user profiles. The method additionally includes generating a notification message indicative of the product or service, and transmitting the notification message to the particular user profile via the client application.

In one or more other example embodiments of the disclosure, a system including a central trusted server for enabling electronic commerce using social media services is disclosed. The system includes at least one memory storing computer-executable instructions and at least one processor configured to access the at least one memory and execute the computer-executable instructions to perform a set of operations. The operations include receiving, by a central trusted server from a client application executing on a client device, social networking credentials associated with a particular user profile, and determining a group of one or more trusted user profiles associated with the particular user profile. The set of operations further includes determining a product or service to recommend to the particular user profile based at least in part on an analysis of online activity associated with the group of one or more trusted user profiles. The set of operations additionally includes generating a notification message indicative of the product or service, and transmitting the notification message to the particular user profile via the client application.

In one or more other example embodiments of the disclosure, a computer program product is disclosed that comprises a non-transitory storage medium readable by a processing circuit, the storage medium storing instructions executable by the processing circuit to cause a method to be performed. The method includes receiving, by a central trusted server from a client application executing on a client device, social networking credentials associated with a particular user profile. The method further includes determining a group of one or more trusted user profiles associated with the particular user profile, and determining a product or service to recommend to the particular user profile based at least in part on an analysis of online activity associated with the group of one or more trusted user profiles. The method additionally includes generating a notification message indicative of the product or service, and transmitting the notification message to the particular user profile via the client application.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic block diagram illustrating an e-commerce/social media integrated platform that includes a central trusted service for providing e-commerce capabilities that leverage social media services in accordance with one or more example embodiments of the disclosure.

FIG. 2 is a process flow diagram of a method in accordance with one or more example embodiments of the disclosure.

FIG. 3 is a process flow diagram of another method in accordance with one or more example embodiments of the disclosure.

FIG. 4 is a schematic diagram of an illustrative networked architecture in accordance with one or more example embodiments of the disclosure.

### DETAILED DESCRIPTION

Example embodiments of the disclosure include, among other things, systems, methods, computer-readable media, techniques, and methodologies for integrating e-commerce capabilities with social media services using a central trusted service. A client application executable on a client device (e.g., a mobile application executing on a mobile device such as a smartphone or tablet device) may interact with a central trusted e-commerce/social media service executing on one or more servers. The central trusted service may receive social networking credentials associated with a user from the client application. The central trusted service may identify a particular user profile (e.g., a social networking user profile) associated with the user based at least in part on the received social networking credentials. The central trusted service may further determine a group of trusted user profiles linked to the particular user profile. The central trusted service may analyze product browsing data, product purchase data, social media data, or the like associated with the group of trusted user profiles to identify one or more products to recommend or otherwise target to the particular user profile. In addition, the central trusted service may provide a direct, centralized conduit to online retailers to allow the user to purchase a product via a trusted and secure mechanism. Further, according to example embodiments of the disclosure, the central trusted service may also provide a centralized data feed for cognitive analysis. The results of the cognitive analysis of the data feed may be used to provide feedback to a consumer, his/her associated trusted social circles, and/or online retailers.

Web browsing history, online search history, user sentiment expressed on social media websites (e.g., “likes” or “favorites”), or the like may be analyzed to target online advertising to online users. With respect to the realm of e-commerce, merchant websites may provide consumers with product detail pages that provide various information regarding products (e.g., product price, product description, product specifications, etc.). Consumer feedback may also be provided for a product such as, for example, customer reviews and rankings. In addition, merchant websites may also provide information regarding related products that were purchased, browsed, or reviewed in connection with a particular product. Tools may also be provided (e.g., mobile applications) that offer the capability to negotiate the best price for a product.

However, despite the capabilities noted above, existing social media services and existing e-commerce platforms do not provide the capability that embodiments of the disclosure do to push specific products to a consumer online such that like-minded consumers extend that directed push at the point-of-sale. For example, while existing social media services may enable notifications that provide web links to online stores, such existing services do not provide direct links to online shopping carts at online stores that carry a specific product nor do they directly associate a user's social networking account with user accounts at such online stores. By providing the capability to directly link a social networking user profile to a user account at an online store, example embodiments of the disclosure provide a more streamlined user experience.

Moreover, example embodiments of the disclosure provide a capability to improve sales analytics through cognitive analysis of a variety of types of e-commerce and social media data. For example, the centralization of sales data at a central trusted service allows the central trusted service to determine, for any given user, the circle of online merchants trusted by the user, the circle of trusted users linked to the user and their respective trusted online merchants, and so on, as well as, associated buying patterns of all users. The central trusted service may perform cognitive analysis of such data to improve relevancy of products targeted to users, to increase the competitive advantage of online merchants, and so forth.

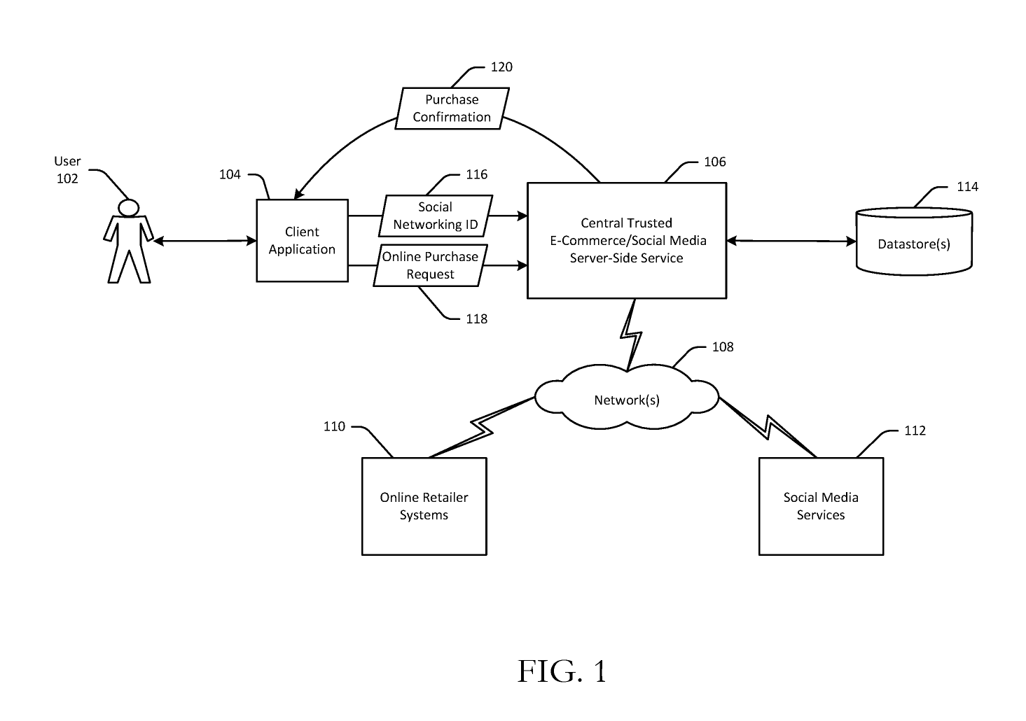

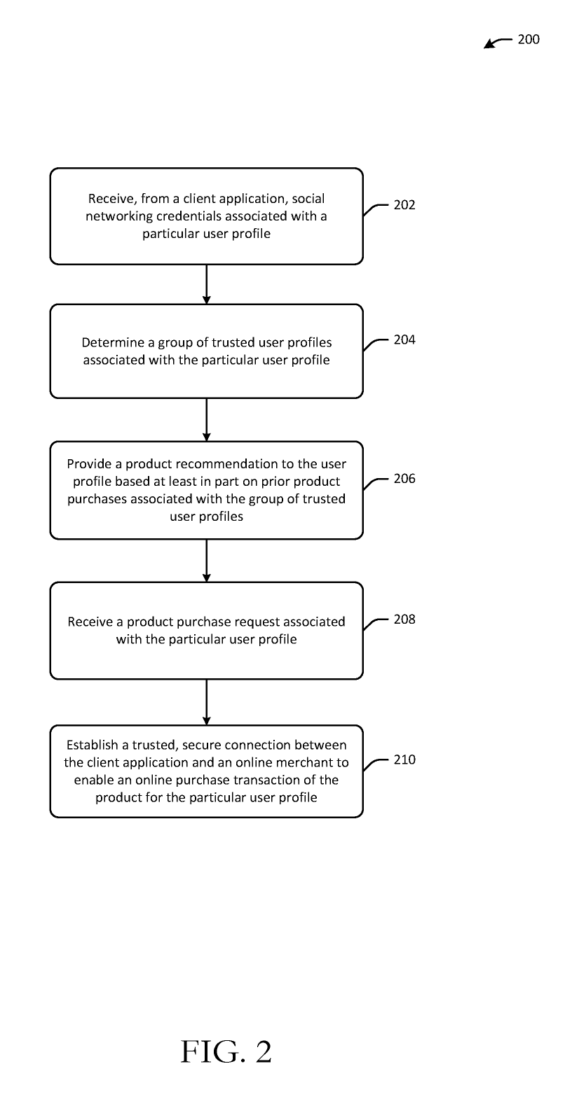

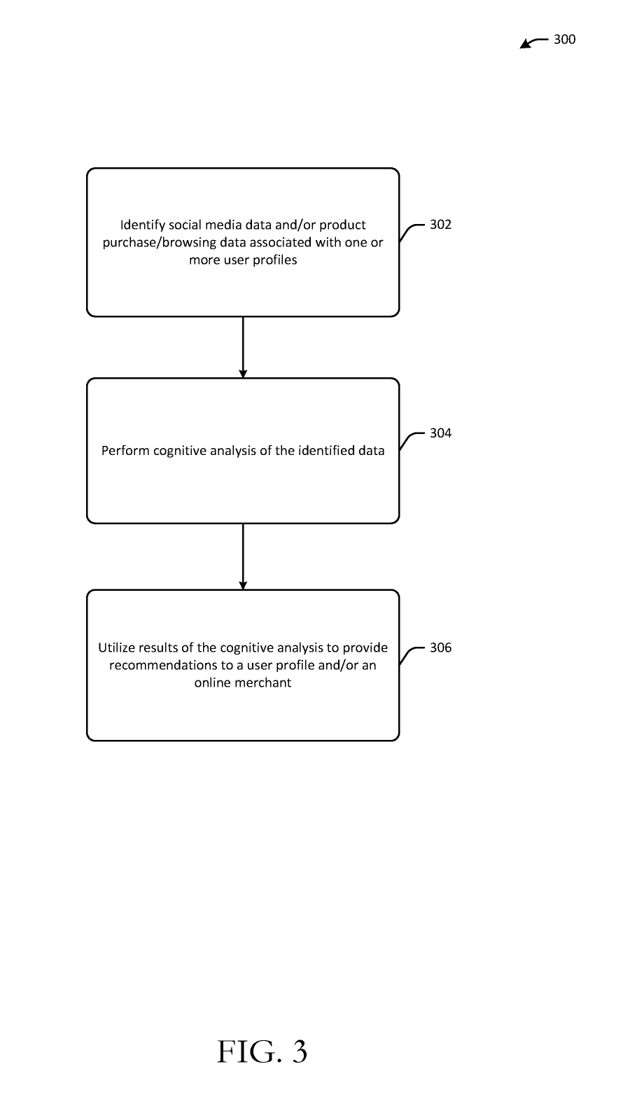

FIG. 1 is a schematic block diagram illustrating an e-commerce/social media integrated platform that includes a central trusted service for providing e-commerce capabilities that leverage social media services in accordance with one or more example embodiments of the disclosure. FIG. 2 is a process flow diagram of a method 200 in accordance with one or more example embodiments of the disclosure. FIG. 3 is a process flow diagram of another method 300 in accordance with one or more example embodiments of the disclosure. FIG. 1 will be described in conjunction with FIGS. 2 and 3 hereinafter.

One or more operations of the methods 200 or 300 may be performed by one or more engines, or more specifically, by one or more program modules or sub-modules forming part of such engine(s). An engine, or more specifically, a module contained therein, which may itself contain or be a collection of one or more sub-modules, may include computer-executable instructions that when executed by a processing circuit may cause one or more operations to be performed. A processing circuit may include one or more processing units or nodes. Computer-executable instructions may include computer-executable program code that when executed by a processing unit may cause input data contained in or referenced by the computer-executable program code to be accessed and processed to yield output data. Any engine or module described herein may be implemented in any combination of software, hardware, and/or firmware.

FIG. 1 depicts a central trusted e-commerce/social media server-side service 106 (hereinafter referred to as a central trusted service) configured to interact with a client application 104. While not depicted in FIG. 1, it should be appreciated that the client application 104 may be executing on a user device including, without limitation, a smartphone, a tablet, a content streaming device, a personal computer, or the like. It should be further appreciated that the central trusted service 106 may execute on one or more servers, potentially in a distributed fashion.

The central trusted service 106 may be configured to communicate with one or more online retailer systems 110 and one or more social media services 112 via one or more networks 108. The network(s) 108 may include, without limitation, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The network(s) 108 may have any suitable communication range associated therewith and may include, for example, global networks (e.g., the Internet), metropolitan area networks (MANs), wide area networks (WANs), local area networks (LANs), or personal area networks (PANs). In addition, the network(s) 108 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

The online retailer systems 110 may be operated by, for example, one or more third party online merchants. In other example embodiments, an online retailer system 110 may be operated or controlled by a same entity that operates the central trusted service 106. The central trusted service 106 may store financial transaction data (e.g., payment card information) associated with user profiles in a secure manner and may utilize the financial transaction data to initiate financial transactions with online retailers on behalf of users. In certain example embodiments, the central trusted service 106 may provide financial transaction data to an online retailer system 110 via a secure communication channel to initiate a transaction for a product or service desired by a user.

The social media services 112 may include one or more third-party social media platforms and/or one or more social media services operated by a same entity that operates the central trusted service 106. The social media services 112 may provide various social networking capabilities including, without limitation, the capability to create a social network link between social networking user profiles that allows the user profiles to share information with one another; the capability for a first social networking user profile to “follow” a second social networking user profile and view information shared by the second social networking user profile; the capability to express user sentiment (e.g., “likes,” “favorites,” etc.) with respect to information shared by a social networking user profile; and so forth.

In addition, a social media service 112 may itself provide, or the central trusted service 106 may provide via, for example, an Application Programming Interface (API), the capability for a social networking user profile to designate another user profile as a trusted user profile. If, for example, a first user profile is designated as a trusted user profile for a second user profile, the central trusted service 106 may utilize historical product purchase data, online search/browsing history, or the like associated with the first user profile to target product recommendations to the second user profile that are more likely to result in product purchases by the user associated with the second user profile due to the trusted nature of the first user profile.

The central trusted service 106 may be configured to read data from and write data to one or more datastores 114. For example, the central trusted service 106 may access/store social networking user profile data; user search history data; user browsing history data; user purchase history data; online merchant data (e.g., product data); financial data (e.g., payment card information); and so forth from/in the datastore(s) 114. The central trusted service 106 may also access/store data relating to product recommendations from/in the datastore(s) 114. In addition, the central trusted service 106 may access/store information regarding which user profiles are trusted profiles for a particular user profile from/in the datastore(s) 114.

Referring now to FIGS. 1 and 2 in conjunction with one another, at block 202 of method 200, the central trusted service 106 may receive, from a client application 104, social networking credentials 116 associated with a particular user profile. For example, a user 102 may provide input to the client application 104 corresponding to a social networking ID and password for a social networking user profile associated with the user 102. The client application 104 may be a thin-client application such as a web-based application, a thick-client application, a mobile application, or the like.

At block 204, the central trusted service 106 may determine a group of trusted user profiles associated with the particular user profile. For example, the central trusted service 106 may provide the social networking credentials 116 received at block 202 to a social media service 112 which may, in turn, provide the central trusted service 106 with an indication of trusted user profile(s) linked to the particular user profile. The particular user profile may have previously designated each user profile in the group of user profiles identified at block 204 as a trusted user profile.

At block 206, the central trusted service 106 may provide a product recommendation to the particular user profile based at least in part on prior product purchases associated with the group of trusted user profiles. For example, if a user profile in the group of trusted user profiles queues up a product for purchase in an online shopping cart associated with an online retailer system 110 and/or purchases the product, an indication may be provided to the particular user profile to encourage the user associated with the particular user profile to purchase the product or a related product. In addition to, or as alternative to, product purchase data, the central trusted service 106 may rely on search/browsing activity, user sentiment data (e.g., customer reviews), or the like associated with the group of trusted user profiles to make the product recommendation at block 206.

At block 208, the central trusted service 106 may receive a product purchase request 118 from the client application 104. For example, the central trusted service 106 may receive a purchase request 118 initiated by the user 102 via input provided to the client application 104. The purchase request 118 may correspond to the product recommended at block 206. At block 210, the central trusted service 106 may establish a trusted, secure connection between the client application 104 and an online retailer system 110 to enable an online purchase transaction of the product for the particular user profile. In such a manner, the central trusted service 106 may centralize a social media and online purchase experience for the user 102.

It should be appreciated that the purchase transaction is not limited to a retail purchase, but may include the purchase of a service such as a travel service, a health service, or the like. Further, with the home delivery of consumables on the rise, the purchase transaction may be for any number of grocery items, potentially filtered by store and brand.

A specific non-limiting example of how the central trusted service 106 may interact with the client application 104, an online retailer system 110, and a social media service 112 to implement the method 200 will now be described. A social media service 112 operated or otherwise leveraged by the central trusted service 106 may provide various capabilities for a user profile to establish virtual social connections with other user profiles. For example, a social media service 112 may provide the capability for a first social networking user profile to “friend” a second social networking user profile such that the two profiles can share information with one another. As another example, a social media service 112 may provide the capability for a first social networking profile to “follow” a second social networking profile, which may allow the first social networking profile to obtain certain information that is publicly shared by the second social networking profile. An existing social network, for example, provides a variety of interface options for social interaction for a social networking user profile including the capability to “follow” another social networking user profile; the capability to generate an electronic message that may be shared with “followers;” the capability to re-share an electronic message generated by another social networking user profile; the capability to indicate user sentiment with respect to an electronic message generated by another social networking user profile; and so forth.

E-commerce websites typically provide a unique web page (sometimes referred to as a product detail page) for each specific product. The product detail page for a product may be uniquely identified by a corresponding uniform resource locator (URL). Further, the product may be uniquely identified by a stocking code such as, for example, a stock keeping unit (SKU). Online merchant websites typically have a large selection of products available for purchase. However, despite continued attempts to provide more user-friendly interfaces, specific products may be difficult to locate among the multitude of product detail pages. When a web page for a product is located, online customer reviews can help to discern a product's quality. However, outliers can skew the accuracy of such reviews. Further, the customer reviews may not reflect similar perspectives of a prospective buyer. For example, a buyer may be concerned with different features and/or functionality than what customer reviews may focus on. In addition, an element of trust is lacking from such customer reviews. For example, certain customer reviews may be intentionally misleading as to the quality and/or characteristics of the product being reviewed.

Example embodiments of the disclosure provide a new form of social media that combines social network interactions with e-commerce capabilities. Via the client application 104 (e.g., a mobile application), the user 102 may access a social networking user profile with a social media service 112. The social media service 112 may provide the capability for the accessed social networking user profile to “follow” one or more other social networking user profiles. More specifically, the social media service 112 may provide the capability to designate another social networking user profile as a trusted user profile such that search/browsing/purchase data associated with the trusted user profile may be used to provide more relevant targeted product advertising and/or more relevant product recommendations to the user's social networking profile. The social media service 112 may also provide the capability for a social networking user profile to designate an online merchant as a trusted merchant. If a social networking user profile has designated an online merchant as a trusted merchant, the central trusted service 106 may link the social networking user profile to a corresponding user account with the trusted online merchant and may share payment information for the user with the online merchant. In this manner, the client application 104 operating in conjunction with the central trusted service 106 may become a centralized conduit for queuing up specific products in online shopping carts with various online merchants and providing purchase confirmations.

After a purchase of a product is completed by a particular user profile, the central trusted service 106 may also generate notifications that may be sent to each other user profile for which the particular user profile is a trusted user profile. The notifications may be presented to each such user profile via the client application 104. In this manner, user profiles “following” the particular user profile may be encouraged to also purchase the product or a related product. Recommendations of the product may propagate through the social media service 112 to additional trusted social circles of the user profiles “following” the particular user profile. The central trusted service 106 may also be configured to generate notifications of products for which user profiles generated ratings or reviews and push the notifications to other user profiles within the same trusted circles.

In certain example embodiments, both social networking user profiles as well as online merchants may target products to specific social circles. For example, online merchants may push selected products to particular social circles at sale prices over specific timeframes. Further, social networking user profiles that have a large number of followers (e.g., user profiles of celebrities) may push specific products (e.g., products associated with endorsement deals) to their followers which, in turn, may propagate to the social circles of the “follower” user profiles.

The client application 104 may be configured to provide a variety of types of functionality. For example, the client application 104 may determine the lowest price for a product among all online stores with which a user has a corresponding user account, which may drive price matches and encourage other users to establish user accounts with a multitude of online stores, which may produce a ripple effect and encourage more online stores to establish a relationship with the central trusted service 106. The client application 104 may be further configured to determine lowest shipping costs, most expedited shipping options, lowest product prices, and/or most preferred carriers among different online retailers. The client application 104 may additionally be configured to respond to customer queries in real-time based on centralized data available to the central trusted service 106.

In certain example embodiments, the client application 104 may be provided by a same entity that operates the central trusted service 106. The client application 104 may provide the user 102 with access to a social media user interface that may be hosted by the central trusted service 106 or that may be provided by a social media service 112 and accessed by the client application 104 through an API (with the central trusted service 106 potentially serving as an intermediary between the client application 104 and the social media service 112). In certain example embodiments, the central trusted service 106 and/or the client application 104 may provide enhanced functionality to a user interface provided by a social media service 112. The social media user interface accessible via the client application 104 may provide the capability to designate a social networking user profile as a trusted user profile. In this manner, a social networking user profile may become a trusted user profile to a group of one or more following user profiles. The social media user interface may further provide the capability for a user profile to generate a product notification message associated with a specific product. The product notification message may optionally include an image of the product and a URL for a product detail page of the product at an online store. Multiple URLs directing to multiple product detail pages at different online stores may be provided in a single product notification message or in respective product notification messages. In certain example embodiments, the online stores may be designated by a user profile as trusted online merchants.

A product notification message may be generated through any of a variety of mechanisms. For example, a product notification message may be generated when a user profile promotes a product, purchases a product, and/or provides a review or rating for a product. In certain example embodiments, the product notification message may have a unique icon or other indicia associated therewith that identifies the product notification message as one relating to a product promoted, purchased, reviewed, rated, searched, or browsed by a trusted user profile. Generation and dissemination of a product notification message may encourage user profiles that receive the product notification message to share the message with other user profiles (e.g., following user profiles); to associate with additional user profiles that purchased, browsed, searched, or reviewed the product; or the like. The client application 104 may capture aggregate information relating to product notification messages shared among all user profiles and/or information specific to particular social circles. The client application 104 may transmit such information to the central trusted service 106.

Information identifying various social circles formed through the social media service 112 accessed via the client application 104, information identifying products purchased (or simply added to online shopping carts) by user profiles associated with the social media service 112, structured categorization of product information across multiple participating online retailers (e.g., product pricing information, product reviews and ratings, etc.), and the like may represent structured data that can be utilized by the central trusted service 106 to provide a competitive advantage to participating online retailers and improve the customer experience for consumers. Availability of such structured data allows the central trusted service 106 to monitor social contact shopping and filter the structured data to ensure that product notification messages associated with the most relevant products are disseminated to user profiles based on their networks of trusted user profiles and/or their specified tastes and preferences.

FIG. 3 is a process flow diagram of another method 300 in accordance with one or more example embodiments of the disclosure. The method 300 may be a method for performing cognitive analysis by the central trusted service 106. Referring now to FIGS. 1 and 3 in conjunction with one another, at block 302, the central trusted service 106 may identify social media data and/or product purchase/browsing data associated with one or more user profiles. The data identified at block 302 may include any of the structured data described above and may be accessed from the datastore(s) 114. The data identified at block 302 may further include, without limitation, data indicative of online stores considered at the point-of-sale; the number of product notification messages generated or received for a product; data indicative of related products that were reviewed or rated; and so forth. Such data would be available to the central trusted service 106 by virtue of the client application 104 monitoring the online purchase experience from promotion of a product through dissemination of a product notification message through a product sale (or a lost sale opportunity).

At block 304, the central trusted service 106 may perform cognitive analysis of the data identified at block 302. At block 306, the central trusted service 106 may utilize the results of the cognitive analysis to provide recommendations to a user profile and/or to an online merchant. For example, based on the results of the cognitive analysis, the central trusted service 106 may make recommendations to online retailers to adjust the price points of products; recommendations regarding which types of product to push to consumers; recommendations regarding times of day or year to push specific products; recommendations regarding stocking of products; or the like. As another example, based on the results of cognitive analysis performed on user profiles and corresponding trusted user profiles, the central trusted service 106 may make predictions regarding which products may be most relevant to a user profile (e.g., most likely to be purchased) based on customer feedback provided for the products (e.g., reviews and ratings). As yet another example, based on the results of the cognitive analysis, the central trusted service 106 may make predictions regarding which combinations of products are most likely to be relevant to the preferences of a user profile; which combinations of products are most likely to be purchased by a user profile; and so forth. It should be appreciated that the above examples are merely illustrative and not exhaustive.

In certain example embodiments, the central trusted service 106 may collect unstructured data associated with usage of the client application 104 and perform cognitive analysis on the unstructured data. The usage data may include data relating to social media interactions on a social media service 112 accessed via the client application 104, which may be a social media service operated by a same entity as the client application 104 and/or the central trusted service 106 or a social media service operated by a third party. The usage data may correspond to the social media circles of user profiles and may span multiple social media services 112. In a manner similar to how registration of multiple online stores with the central trusted service 106 centralizes the client application's 104 usage as a purchasing device, registration of multiple social media services 112 for cognitive analysis centralizes the client application's 104 usage as a data feed for improving the relevancy of e-commerce product offerings and recommendations. In addition to social media usage data, the unstructured data may further include product/service purchase data relating to any of a variety of types products or services.

Cognitive analysis of unstructured social media data may include analyzing social media feeds in real-time or in an offline, batch mode by, for example, executing natural language processing (NLP) thereon and performing post-processing on the NLP data to identify patterns, keywords of interest, or the like. The results of the NLP and post-processing may be used to increase the relevancy of product recommendation to consumers and/or improve the sales performance of online retailers. More specifically, the results of cognitive analysis of the unstructured social media data may be used to, without limitation, summarize customer reviews that are relevant to a user profile; provide an overall sentiment analysis pertaining to user experiences with a product; make intelligent recommendations of related products; establish patterns of interest to improve relevancy of product recommendations; or the like.

Example embodiments of the disclosure include or yield various technical features, technical effects, and/or improvements to technology. For instance, example embodiments of the disclosure provide the technical effect of providing end users with integrated e-commerce and social network functionality that allows the end users to initiate purchase transactions for products or services based on social media interactions of trusted user profiles. This technical effect is achieved as a result of the technical feature of providing a central server-side trusted service that supports the integrated e-commerce and social network functionality and that provides access to such functionality via communication with a client application executable on a client device of an end user. Thus, the above-described technical features and their associated technical effects yield an improvement to conventional e-commerce and social media technology. It should be appreciated that the above examples of technical features, technical effects, and improvements to technology provided by example embodiments of the disclosure are merely illustrative and not exhaustive.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

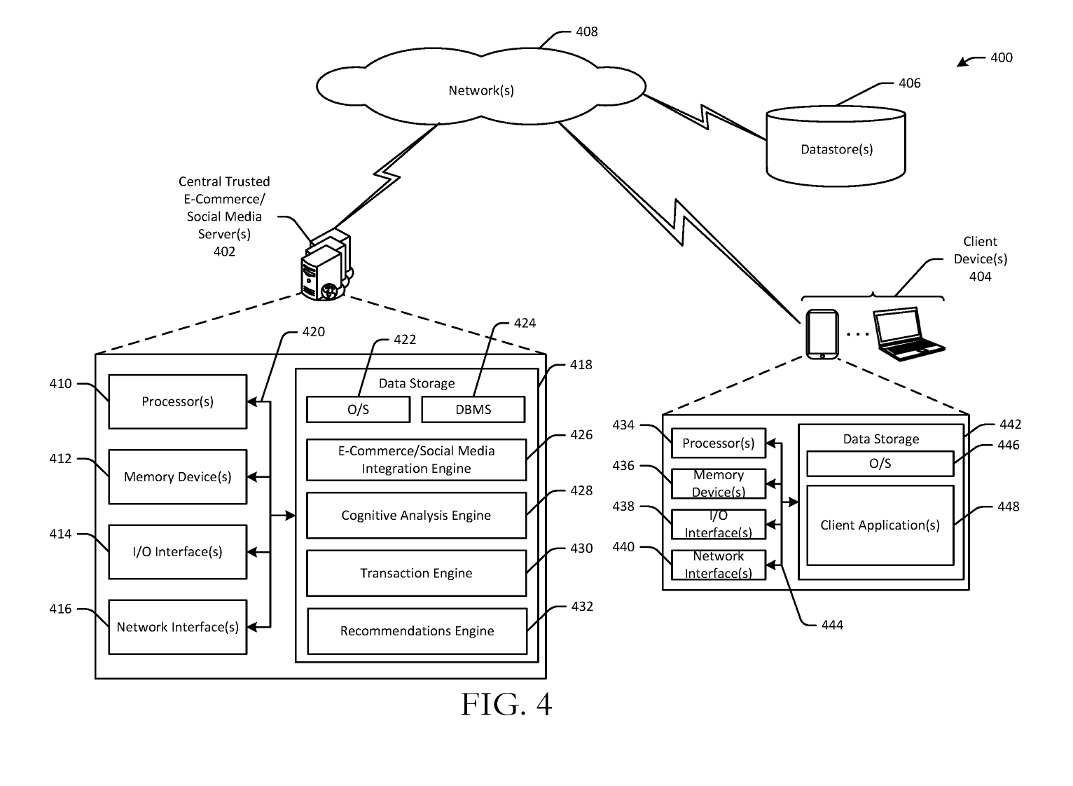

FIG. 4 is a schematic diagram of an illustrative networked architecture 400 in accordance with one or more example embodiments of the disclosure in accordance with one or more example embodiments of the disclosure. The networked architecture 400 may include one or more central trusted e-commerce/social media servers 402 (hereinafter referred to as central trusted servers 402 or simply central trusted server 402). The central trusted server(s) 402 may be configured to execute the central trusted service 106. The central trusted server(s) 402 may be configured to communicate with one or more client devices 404 via one or more networks 408. The network(s) 408 may include any of the types of networks previously described in connection with the network(s) 108. Further, the client device(s) 404 may include any suitable device capable of executing the client application 104. While the central trusted server(s) 402 and/or the client device(s) 404 may be described in the singular hereinafter for ease of explanation, it should be appreciated that multiple central trusted servers 402 and/or multiple client devices 404 may be configured to communicate via the network(s) 408 and that functionality described in connection with a central trusted server 402 and/or a client device 404 may be distributed across multiple central trusted servers 402 and/or multiple client devices 404 in a distributed fashion.

In an illustrative configuration, a central trusted server 402 may include one or more processors (processor(s)) 410, one or more memory devices 412 (generically referred to herein as memory 412), one or more input/output (“I/O”) interface(s) 414, one or more network interfaces 416, and data storage 418. The central trusted server 402 may further include one or more buses 420 that functionally couple various components of the central trusted server 402.

The bus(es) 420 may include at least one of a system bus, a memory bus, an address bus, or a message bus, and may permit exchange of information (e.g., data (including computer-executable code), signaling, etc.) between various components of the central trusted server 402. The bus(es) 420 may include, without limitation, a memory bus or a memory controller, a peripheral bus, an accelerated graphics port, and so forth. The bus(es) 420 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 412 of the central trusted server 402 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 412 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 412 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 418 may include removable storage and/or non-removable storage including, but not limited to, magnetic storage, optical disk storage, and/or tape storage. The data storage 418 may provide non-volatile storage of computer-executable instructions and other data. The memory 412 and the data storage 418, removable and/or non-removable, are examples of computer-readable storage media (CRSM) as that term is used herein.

The data storage 418 may store computer-executable code, instructions, or the like that may be loadable into the memory 412 and executable by the processor(s) 410 to cause the processor(s) 410 to perform or initiate various operations. The data storage 418 may additionally store data that may be copied to memory 412 for use by the processor(s) 410 during the execution of the computer-executable instructions. Moreover, output data generated as a result of execution of the computer-executable instructions by the processor(s) 410 may be stored initially in memory 412 and may ultimately be copied to data storage 418 for non-volatile storage.

More specifically, the data storage 418 may store one or more operating systems (O/S) 422; one or more database management systems (DBMS) 424 configured to access the memory 412 and/or one or more of datastores 406; and one or more program modules, applications, engines, computer-executable code, scripts, or the like such as, for example, an e-commerce/social media integration engine 426, a cognitive analysis engine 428, a transaction engine 430, and a recommendations engine 432. Any of the components depicted as being stored in data storage 418 may include any combination of software, firmware, and/or hardware. The software and/or firmware may include computer-executable instructions (e.g., computer-executable program code) that may be loaded into the memory 412 for execution by one or more of the processor(s) 410 to perform corresponding operations described earlier in this disclosure.

In certain example embodiments, the e-commerce/social media integration engine 426, the cognitive analysis engine 428, the transaction engine 430, and the recommendations engine 432 may form part of the central trusted service 106. The e-commerce/social media integration engine 426 may, for example, be configured to integrate e-commerce functionality with social media service functionality to provide an integrated e-commerce and social media experience accessible to a user via the client application 104, as described in example embodiments herein. The transaction engine 430 may be configured to execute secured financial transactions between a consumer and an online merchant based on purchase requests received via the client application 104. The cognitive analysis engine 428 may be configured to perform cognitive analysis of various structured and/or unstructured data (e.g., social media data, product search data, product browsing data, product purchase data, etc.) as described in example embodiments herein. The recommendations engine 432 may be configured to generate and disseminate product recommendations (e.g., product notification messages) to users of the client application 104 as described in example embodiments herein.

Although not depicted in FIG. 4, the data storage 418 may further store various types of data utilized by components of the central trusted server 402 (e.g., structured and/or unstructured data). Any data stored in the data storage 418 may be loaded into the memory 412 for use by the processor(s) 410 in executing computer-executable instructions. In addition, any data stored in the data storage 418 may potentially be stored in one or more external datastores (e.g., one or more of the datastores 406) and may be accessed via the DBMS 424 and loaded in the memory 412 for use by the processor(s) 410 in executing computer-executable instructions.

The processor(s) 410 may be configured to access the memory 412 and execute computer-executable instructions loaded therein. For example, the processor(s) 410 may be configured to execute computer-executable instructions of the various program modules, applications, engines, or the like of the central trusted server 402 to cause or facilitate various operations to be performed in accordance with one or more embodiments of the disclosure. The processor(s) 410 may include any suitable processing unit capable of accepting data as input, processing the input data in accordance with stored computer-executable instructions, and generating output data. The processor(s) 410 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 410 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 410 may be capable of supporting any of a variety of instruction sets.

Referring now to other illustrative components depicted as being stored in the data storage 418, the O/S 422 may be loaded from the data storage 418 into the memory 412 and may provide an interface between other application software executing on the central trusted server 402 and hardware resources of the central trusted server 402. More specifically, the O/S 422 may include a set of computer-executable instructions for managing hardware resources of the central trusted server 402 and for providing common services to other application programs (e.g., managing memory allocation among various application programs). In certain example embodiments, the O/S 422 may control execution of one or more of the program modules depicted as being stored in the data storage 418. The O/S 422 may include any operating system now known or which may be developed in the future including, but not limited to, any server operating system, any mainframe operating system, or any other proprietary or non-proprietary operating system.

The DBMS 424 may be loaded into the memory 412 and may support functionality for accessing, retrieving, storing, and/or manipulating data stored in the memory 412, data stored in the data storage 418, and/or data stored in the datastore(s) 406. In certain example embodiments, the central trusted server 106 may access the datastore(s) 406 via the network(s) 408. The DBMS 424 may use any of a variety of database models (e.g., relational model, object model, etc.) and may support any of a variety of query languages. The DBMS 424 may access data represented in one or more data schemas and stored in any suitable data repository. In certain example embodiments, the DBMS 424 may be NoSQL (e.g., column, document, key-value, graph, multi-model, etc.), and thus, more efficient in representing unstructured data. Further, in certain example embodiments, the DBMS 424 may be schema-less. The datastore(s) 406 that may be accessible by the central trusted server 402 via the DBMS 424 may include, but are not limited to, databases (e.g., relational, object-oriented, etc.), file systems, flat files, distributed datastores in which data is stored on more than one node of a computer network, peer-to-peer network datastores, or the like. The datastore(s) 406 may store various types of data including, without limitation, any of the types of data previously described. It should be appreciated that, in certain example embodiments, any external datastore and/or any of the data residing thereon may additionally, or alternatively, be stored locally in the data storage 418.

Referring now to other illustrative components of the central trusted server 402, the input/output (I/O) interface(s) 414 may facilitate the receipt of input information by the central trusted server 402 from one or more I/O devices as well as the output of information from the central trusted server 402 to the one or more I/O devices. The I/O devices may include any of a variety of components such as a display or display screen having a touch surface or touchscreen; a data input device such as a keyboard, mouse, touchpad, etc.; an audio output device for producing sound, such as a speaker; an audio capture device, such as a microphone; an image and/or video capture device, such as a camera; a haptic unit; and so forth. Any of these components may be integrated into the central trusted server 402 or may be separate. The I/O devices may further include, for example, any number of peripheral devices such as data storage devices, printing devices, and so forth.

The I/O interface(s) 414 may also include an interface for an external peripheral device connection such as universal serial bus (USB), FireWire, Thunderbolt, Ethernet port or other connection protocol that may connect to one or more networks. The I/O interface(s) 414 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The central trusted server 402 may further include one or more network interfaces 416 via which the central trusted server 402 may communicate with any of the other system(s) 404 including any platforms, networks, devices, and so forth. The network interface(s) 416 may enable communication, for example, with the other system(s) 404 via one or more of the network(s) 408.

A client device 404 may include one or more processors (processor(s)) 434, one or more memory devices 436 (generically referred to herein as memory 436), one or more input/output (“I/O”) interface(s) 438, one or more network interfaces 440, and data storage 442. The client device 404 may further include one or more buses 444 that functionally couple various components of the client device 404. The data storage 442 may store, for example, one or more operating systems 446 and one or more client applications 448. The client application(s) 448 may include, for example, the client application 104. The other hardware and software components illustratively depicted as part of the client device 404 may include any of the types of components previously described in connection with similarly named components of the central trusted server 402.

It should be appreciated that the engines depicted in FIG. 4 as being stored in the data storage 418 are merely illustrative and not exhaustive and that processing described as being supported by any particular engine may alternatively be distributed across multiple engines, modules, or the like, or performed by a different engine, module, or the like. In addition, various program module(s), script(s), plug-in(s), Application Programming Interface(s) (API(s)), or any other suitable computer-executable code hosted locally on the central trusted server 402 and/or hosted on other computing device(s) accessible via one or more of the network(s) 408, may be provided to support functionality provided by the engines depicted in FIG. 4 and/or additional or alternate functionality. Further, functionality may be modularized differently such that processing described as being supported collectively by a collection of engines depicted in FIG. 4 may be performed by a fewer or greater number of engines or program modules, or functionality described as being supported by any particular engine may be supported, at least in part, by another engine. In addition, engines that support the functionality described herein may form part of one or more applications executable across any number of computing devices of the central trusted server 402 in accordance with any suitable computing model such as, for example, a client-server model, a peer-to-peer model, and so forth. In addition, any of the functionality described as being supported by any of the engines depicted in FIG. 4 may be implemented, at least partially, in hardware and/or firmware across any number of devices.

It should further be appreciated that the central trusted server 402 may include alternate and/or additional hardware, software, or firmware components beyond those described or depicted without departing from the scope of the disclosure. More particularly, it should be appreciated that software, firmware, or hardware components depicted as forming part of the central trusted server 402 are merely illustrative and that some components may not be present or additional components may be provided in various embodiments. While various illustrative engines have been depicted and described as software modules stored in data storage 418, it should be appreciated that functionality described as being supported by the engines may be enabled by any combination of hardware, software, and/or firmware. It should further be appreciated that each of the above-mentioned engines may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular engine may, in various embodiments, be provided at least in part by one or more other engines. Further, one or more depicted engines may not be present in certain embodiments, while in other embodiments, additional engines or modules not depicted may be present and may support at least a portion of the described functionality and/or additional functionality.

One or more operations of the methods 200 and/or 300 may be performed by a central trusted server 402 and/or a client device 404 having the illustrative configurations depicted in FIG. 4, or more specifically, by one or more program modules, engines, applications, or the like executable on such devices. It should be appreciated, however, that such operations may be implemented in connection with numerous other device configurations.

The operations described and depicted in the illustrative methods 200 and 300 of FIGS. 2 and 3, respectively, may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 2 and 3 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like may be additionally based on one or more other operations, elements, components, data, or the like. Accordingly, the phrase “based on,” or variants thereof, should be interpreted as “based at least in part on.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for enabling electronic commerce using social media services, the method comprising:
receiving, by a central trusted server from a client application executing on a client device, social networking credentials associated with a particular user profile;
determining a group of one or more trusted user profiles associated with the particular user profile;
determining a product or service to recommend to the particular user profile based at least in part on an analysis of online activity associated with the group of one or more trusted user profiles;
generating a notification message indicative of the product or service; and
transmitting the notification message to the particular user profile via the client application.

2. The computer-implemented method of claim 1, wherein the notification message comprises a link to a web page hosted by an online merchant via which the product is purchasable.

3. The computer-implemented method of claim 1, further comprising:
receiving, by the central trusted server from the client application on behalf of a user of the client application, a purchase request to purchase the product;
establishing a secure connection with an online merchant offering the product for sale; and
transmitting payment information associated with the particular user profile via the secure connection to enable a purchase of the product.

4. The computer-implemented method of claim 3, wherein the online merchant is registered with a central trusted service executing on the central trusted server.

5. The computer-implemented method of claim 1, further comprising:
identifying, by the central trusted server, usage data associated with the client application;
performing cognitive analysis of the usage data; and
determining a recommendation to make to the particular user profile or an online merchant based at least in part on results of the cognitive analysis.

6. The computer-implemented method of claim 5, wherein the recommendation comprises a recommendation to purchase a related product or service associated with the product or service or a recommendation to adjust a price point of the product or service.

7. The computer-implemented method of claim 5, wherein the usage data comprises social media data associated with at least one of the particular user profile or the group of one or more trusted user profiles on one or more third party social media services.

8. A system comprising a central trusted server for enabling electronic commerce using social media services, the system comprising:
at least one memory storing computer-executable instructions; and
at least one processor configured to access the at least one memory and execute the computer-executable instructions to:
receive, from a client application executing on a client device, social networking credentials associated with a particular user profile;
determine a group of one or more trusted user profiles associated with the particular user profile;
determine a product or service to recommend to the particular user profile based at least in part on an analysis of online activity associated with the group of one or more trusted user profiles;
generate a notification message indicative of the product or service; and
transmit the notification message to the particular user profile via the client application.

9. The system of claim 8, wherein the notification message comprises a link to a web page hosted by an online merchant via which the product is purchasable.

10. The system of claim 8, wherein the at least one processor is further configured to execute the computer-executable instructions to:
receive, from the client application on behalf of a user of the client application, a purchase request to purchase the product;
establish a secure connection with an online merchant offering the product for sale; and
transmit payment information associated with the particular user profile via the secure connection to enable a purchase of the product.

11. The system of claim 10, wherein the online merchant is registered with a central trusted service executing on the central trusted server.

12. The system of claim 8, wherein the at least one processor is further configured to execute the computer-executable instructions to:
identify usage data associated with the client application;
perform cognitive analysis of the usage data; and
determine a recommendation to make to the particular user profile or an online merchant based at least in part on results of the cognitive analysis.

13. The system of claim 12, wherein the recommendation comprises a recommendation to purchase a related product or service associated with the product or service or a recommendation to adjust a price point of the product or service.

14. The system of claim 12, wherein the usage data comprises social media data associated with at least one of the particular user profile or the group of one or more trusted user profiles on one or more third party social media services.

15. A computer program product for enabling electronic commerce using social media services, the computer program product comprising a storage medium readable by a processing circuit, the storage medium storing instructions executable by the processing circuit to cause a method to be performed, the method comprising:
receiving, by a central trusted server from a client application executing on a client device, social networking credentials associated with a particular user profile;
determining a group of one or more trusted user profiles associated with the particular user profile;
determining a product or service to recommend to the particular user profile based at least in part on an analysis of online activity associated with the group of one or more trusted user profiles;
generating a notification message indicative of the product or service; and
transmitting the notification message to the particular user profile via the client application.

16. The computer program product of claim 15, wherein the notification message comprises a link to a web page hosted by an online merchant via which the product is purchasable.

17. The computer program product of claim 15, the method further comprising:
receiving, by the central trusted server from the client application on behalf of a user of the client application, a purchase request to purchase the product;
establishing a secure connection with an online merchant offering the product for sale; and
transmitting payment information associated with the particular user profile via the secure connection to enable a purchase of the product.

18. The computer program product of claim 17, wherein the online merchant is registered with a central trusted service executing on the central trusted server.

19. The computer program product of claim 15, the method further comprising:
identifying, by the central trusted server, usage data associated with the client application;
performing cognitive analysis of the usage data; and
determining a recommendation to make to the particular user profile or an online merchant based at least in part on results of the cognitive analysis.

20. The computer program product of claim 19, wherein the recommendation comprises a recommendation to purchase a related product or service associated with the product or service or a recommendation to adjust a price point of the product or service.
